(19) United States
(12) Patent Application Publication
(10) Pub. No.: US 2014/0075312 A1
(43) Pub. Date: Mar. 13, 2014

(54) CONSIDERING USER NEEDS WHEN PRESENTING CONTEXT-SENSITIVE INFORMATION

(71) Applicants: Andrew D. Dingsor, Research Triangle Park, NC (US); Dana L. Price, Cary, NC (US); Dana R. Thalheimer, Cary, NC (US)

(72) Inventors: Andrew D. Dingsor, Research Triangle Park, NC (US); Dana L. Price, Cary, NC (US); Dana R. Thalheimer, Cary, NC (US)

(73) Assignee: INTERNATIONAL BUSINESS MACHINES CORPORATION, Armonk, NY (US)

(21) Appl. No.: 13/612,154

(22) Filed: Sep. 12, 2012

(51) Int. Cl. G06F 3/01

(52) U.S. Cl. 715/716

(57) ABSTRACT

Methods and systems of summarizing media content may provide for receiving a request for a presentation of media content to a user, and determining a media consumption context associated with the user and the media content, wherein the media consumption context includes an amount of time between media consumption sessions. Additionally, a level of detail for a summary of the media content may be determined based on the media consumption context. In one example, the media consumption context further includes one or more of an amount of media consumed in a most recent media consumption session, an information retention capacity of the user, a complexity of the media content, a granularity input from the user, and a user preference setting.

### CROSS-REFERENCE TO RELATED APPLICATIONS

The present application is a continuation of U.S. patent application Ser. No. 13/609,576 filed on Sep. 11, 2012.

### BACKGROUND

Embodiments of the present invention generally relate to the presentation of media content to users. More particularly, embodiments relate to the use of media consumption context information to present media content summaries to users.

Summary information may be made available within electronic media such as streaming media, DVDs (digital versatile disks) or eBooks (electronic books). Traditionally, however, this information does not take into account the needs or preferences of the user. For example, a reader of an eBook may be presented with the same summary information regardless of whether he or she was last reading the eBook a day ago, a week ago or a year ago.

### BRIEF SUMMARY

Embodiments may include a computer implemented method in which a request for a presentation of media content to a user is received. The method can also provide for determining a media consumption context associated with the user and the media content, wherein the media consumption context includes an amount of time between media consumption sessions. Additionally, the method may involve determining a level of detail for a summary of the media content based on the media consumption context.

Embodiments may also include a computer program product having a computer readable storage medium and computer usable code stored on the computer readable storage medium. If executed by a processor, the computer usable code may cause a device to receive a request for a presentation of media content to a user, and determine a media consumption context associated with the user and the media content, wherein the media consumption context is to include an amount of time between media consumption sessions. The computer usable code may also cause the device to determine a level of detail for a summary of the media content based on the media consumption context.

Embodiments may also include a media device having a media source with one or more of a network controller and a memory. The media device can also have a user interface (UI) device to receive a request for a presentation of media content to a user, and a context module to determine a media consumption context associated with the user and the media content, wherein the media consumption context is to include an amount of time between media consumption sessions. The media device may also have a summary module to determine a level of detail for a summary of the media content based on the media consumption context.

Embodiments can also include a computer implemented method in which a request for a presentation of media content to a user is received, wherein the media content includes one or more of an eBook, a movie, an episode of a television series, and a video game. The method may also provide for obtaining the media content, and determining a media consumption context associated with the user and the media content, wherein the media consumption context includes an amount of time between media consumption sessions. Additionally, the method can involve determining a level of detail for a summary of the media content based on the media consumption context, increasing the level of detail if the amount of time between media consumption sessions exceeds a threshold, and decreasing the level of detail if the amount of time between media consumption sessions does not exceed the threshold. Moreover, the method may provide for determining the summary based on the level of detail, presenting the summary to the user, wherein the summary includes one or more of plot information and character information, and presenting the media content to the user.

Embodiments may also include a computer program product having a computer readable storage medium and computer usable code stored on the computer readable storage medium. If executed by a processor, the computer usable code may cause a device to receive a request for a presentation of media content to a user, wherein the media content is to include one or more of an eBook, a movie, an episode of a television series, and a video game. The computer usable code may also cause the device to obtain the media content and determine a media consumption context associated with the user and the media content, wherein the media consumption context is to include an amount of time between media consumption sessions. Additionally, the computer usable code can cause the device to determine a level of detail for a summary of the media content based on the media consumption context, increase the level of detail if the amount of time between media consumption sessions exceeds a threshold, and decrease the level of detail if the amount of time between media consumption sessions does not exceed the threshold. Moreover, the computer usable code may cause the device to determine the summary based on the level of detail, present the summary to the user, wherein the summary is to include one or more of plot information and character information, and present the media content to the user.

Embodiments can also include a media device having a media source with one or more of a network controller and a memory, and a user interface (UI) device to receive a request for a presentation of media content to a user, wherein the media content is to include one or more of an eBook, a movie, an episode of a television series, and a video game. The media device may also have a context module to determine a media consumption context associated with the user and the media content, wherein the media consumption context is to include an amount of time between media consumption sessions. Additionally, the media device can have a summary module to obtain the media content from the media source, determine a level of detail for a summary of the media content based on the media consumption context, increase the level of detail if the amount of time between media consumption sessions exceeds a threshold, and decrease the level of detail if the amount of time between media consumption sessions does not exceed the threshold. The summary module can also determine the summary based on the level of detail, present the summary to the user via the UI device, and present the media content to the user via the UI device, wherein the summary is to include one or more of plot information and character information.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of a scheme of presenting context specific summaries to users according to an embodiment;

FIG. 2 is a plot of a relationship between level of detail and time between sessions according to an embodiment;

FIG. 3 is a block diagram of an example of an eBook configuration having multiple levels of summary detail according to an embodiment;

FIG. 4 is a block diagram of a media device according to an embodiment;

FIG. 5 is a flowchart of an example of a method of presenting context specific summaries to users according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

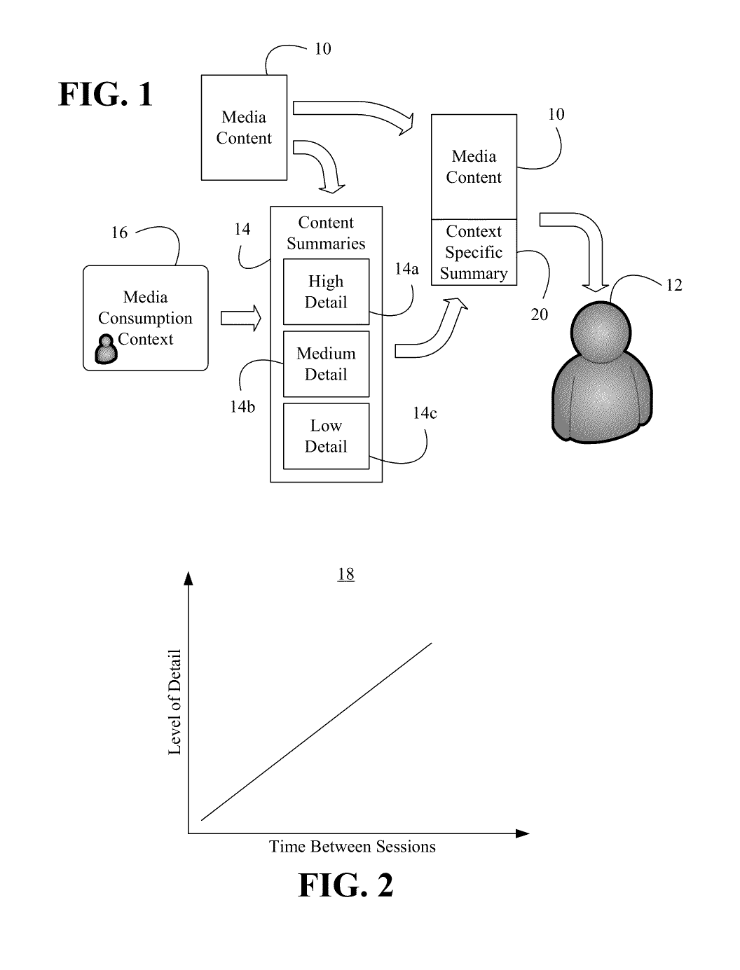

Referring now to FIGS. 1 and 2, an example is shown in which media content 10 is delivered to a user 12 (e.g., via a media device such as a television, computer, smart tablet, smart phone, game console, audio book player, etc., not shown). The illustrated media content 10, which might include an eBook, a movie, an episode of a television (TV) series, a video game, and so forth, may be serial in nature or of a length that lends itself to being experienced by the user 12 in multiple sessions. For example, in the case of an eBook, the user 12 could read a subset (e.g., one or more pages and/or chapters) of the eBook in multiple sessions/sittings over a span of days, weeks, months, and even years. Similarly, in the case of a movie (e.g., streaming video, DVD), the user 12 might pause playing of the video, particularly if the movie is relatively long and/or the user 12 has a busy schedule, and resume watching the movie at a later time/date. If the media content 10 includes a TV series, for example, the user 12 may watch individual episodes of the TV series on a periodic basis.

In the illustrated example, a set of content summaries 14 (14a-14c) may be used to supplement the media content 10 with a summary of the plot, characters, setting, etc., of the media content 10 so that the user 12 is reminded of the state of the story within the media content 10 when the user 12 begins a given media consumption session. The content summaries 14 may be obtained from a producer of the media content 10, obtained from a crowd information source (e.g., social networking, cloud based and/or multi-user database), automatically generated via analysis of the media content 10, determined based on third party reviews, etc., or any combination thereof.

Of particular note is that the particular context 16 in which the user 12 consumes the media content 10 may impact the level of detail to be provided in the summary of the media content 10. For example, if the amount of time since the most recent media consumption session has been relatively short (e.g., minutes, hours, days), it may be inferred that the user 12 still remembers much of the story and does not need for the summary to contain a great amount of detail. If, on the other hand, the amount of time since the most recent media consumption session has been relatively long (e.g., weeks, months, years), it could be inferred that the user may not remember as much of the story and should be presented with a more detailed content summary.

Accordingly, in the illustrated example, the content summaries 14 include a high detail summary 14a, a medium detail summary 14b, and a low detail summary 14c, wherein the summaries 14 can be used to derive, generate and/or select a summary 20 to be presented to the user 12 along with the media content 10. More particularly, the level of detail to be used in the selected summary 20 can be tailored to the media consumption context 16 associated with the user 12 and the media content 10. Accordingly, the summary 20, which can include one or more of the content summaries 14, may be considered context specific in that it is dependent upon the media consumption context 16 that is unique to the user 12 and the media content 10. As best shown in the plot 18 of FIG. 2, in one example, the level of detail in the summary 20 may generally increase as the amount of time between consumption sessions increases, and decrease as the amount of time between consumption sessions decreases.

The media consumption context 16 may also include other factors such as, for example, the amount of media consumed in the most recent media consumption session, the information retention capacity of the user, the complexity of the media content, granularity input from the user (e.g., explicit requests for more/less detail), user preference settings, and so forth. Moreover, each of these additional factors may also trend the level of detail either upward or downward on an individual and/or combined basis. For example, if the media content is relatively complex and/or the user has a relatively low capacity to retain information, the level of detail in the summary might be increased. If, on the other hand, the user has previously requested a reduction in the level of detail or has indicated a desire for a relatively low level of detail in a user preference/setting, the level of detail in the summary 20 could be decreased. Thus, relationships similar to the relationship demonstrated in the plot 18 may be developed for these other factors in order to achieve a robust and fully adaptive content summary solution.

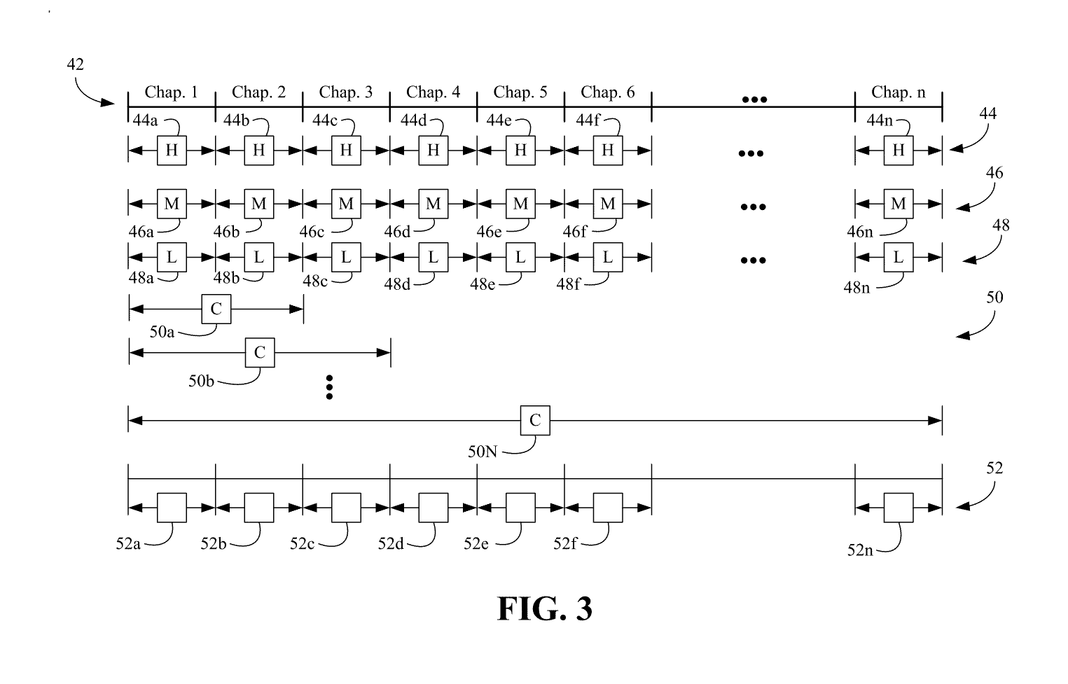

FIG. 3 shows one example of an eBook configuration having multiple levels of summary detail. In the illustrated example, an eBook 42 has n chapters as well as a set of content summaries that includes a plurality of high detail summaries 44 (44a-44n), a plurality of medium detail summaries 46 (46a-46n), a plurality of low detail summaries 48 (48a-48n), a plurality of cumulative summaries 50 (50a-50N), and a plurality of character summaries 52 (52a-52n). If, for example, a user (e.g., Joe) reads a chapter per night, the eBook reader might present the low detail summaries 48 to Joe each night at the onset of each media consumption session in order to provide the briefest level of detail. If, on the other hand, Joe begins to read a chapter every Monday night, the eBook reader may switch to presenting the medium detail summaries 46 at the onset of each media consumption session. Moreover, if upon completing the fifth chapter, Joe stops reading the book for a month, the eBook may present the cumulative summary 50 for chapter five when Joe begins reading chapter six in order to better prepare Joe for that particular media consumption session. If another user (e.g., Mary) reads part of the book once each week, but has requested more detailed summaries in the past, the eBook reader could present Mary with the character summaries 52, the cumulative summaries 50, as well as the high detail summaries 44 in each media consumption session.

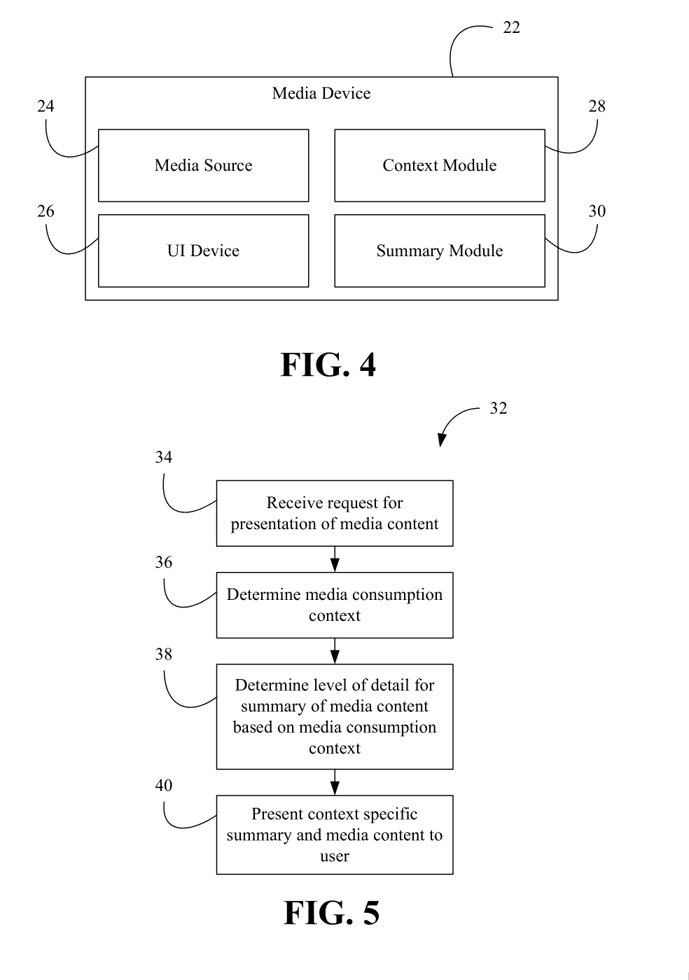

Turning now to FIG. 4, a media device 22 is shown. The media device 22, which may include a TV, desktop computer, notebook computer, smart tablet, smart phone, personal digital assistant (PDA), media player, eBook reader, game console, audio book player, or any combination thereof, can generally be used to deliver media content and summaries of the media content to users such as the user 12 (FIG. 1), already discussed. In the illustrated example, the media device 22 includes a media source 24 such as a network controller, memory, etc., wherein a user interface (UI) device 26 such as a touch screen, keyboard, key pad, microphone, mouse, remote control, etc., may be used to receive a request for a presentation of media content to the user. As already noted, the media content could include an eBook, a movie, an episode of a TV series, a video game, etc. Thus, the media source 24 might include a network controller that obtains the media content from a remote server or could include mass storage such as an optical disk, hard disk drive (HDD) or other non-volatile memory that contains the media content.

The illustrated media device 22 also includes a context module 28 that determines a media consumption context associated with the user and the media content. As already noted, the media consumption context could include the amount of time between media consumption sessions, the amount of media consumed in the most recent media consumption sessions, the information retention capacity of the user, the complexity of the media content, granularity input from the user, user preference settings, and so forth. The media device 22 may also include a summary module 30 to determine a level of detail for a summary of the media content based on the media consumption context and formulate the summary according to the level of detail.

Thus, the summary module 30 might, for example, increase the level of detail if the amount of time between media consumption sessions exceeds a first (e.g., upper) threshold and/or decrease the level of detail if the amount of time between media consumption sessions does not exceed a second (e.g., lower) threshold (or does not exceed the first threshold if a single threshold is used). Moreover, the summary module 30 may obtain the context specific summary from a producer of the media content and/or crowd information source, wherein the media content and the context specific summary may be presented to the user via the UI device 26 (e.g., display, speaker, etc.). The context specific summary may include plot information, character information, setting information, and so forth.

FIG. 5 shows a method 32 of presenting context specific summaries to users. The method 32 may be implemented in a media device such as, for example, the media device 22 (FIG. 2), already discussed. Illustrated processing block 34 provides for receiving a request for a presentation of media content to a user, wherein the media content may include one or more of an eBook, a movie, an episode of a TV series, and a video game. A media consumption context associated with the user and the media content may be determined at block 36, wherein the media consumption context can include factors such as, for example, the amount of time between media consumption sessions, the amount of media consumed in the user's most recent media consumption session, the information retention capacity of the user, the complexity of the media content, granularity input from the user, user preference settings, and so forth.

Additionally, illustrated block 38 determines a level of detail for a summary of the media content based on the media consumption context. For example, if the amount of time between media consumption sessions exceeds a threshold, the level of detail might be increased, whereas if the amount of time between media consumption sessions does not exceed the threshold, the level of detail could be decreased. Moreover, illustrated block 40 provides for determining the summary based on the level detail, and presenting the summary and the media content to the user. Thus, summary information can be presented to the user at the level of granularity that the particular user needs rather than on a generic basis.

For example, consider a scenario in which a user, Pat, reads a chapter in its entirety every day on an eBook reader. At each reading, Pat might only receive a very brief summary such as, “The two characters just left the café where they had been meeting” from the eBook reader. Consider further a situation in which Pat breaks from the chapter per day pattern and, part way through the book, puts it down for a month.

Upon starting up with the book again, the eBook reader may provide a more thorough summary of characters, plot, setting, etc., up to Pat's stopping point, under the techniques described herein.

By way of another example, consider a scenario in which a user, Alex, is following a TV series through an online provider subscription and watches three episodes per week. With each episode viewing session, the TV may present Alex with a “Previously on ‘Some_TV_Show’” summary prior to the start of the new episode, wherein the summary provides enough information to remind Alex of the state of the show. Consider further a situation in which Alex stops watching the TV series for a month. When Alex starts watching again, the TV may automatically provide a more thorough summary of the characters, plot, setting, etc., up to Alex's stopping point.

In yet another example, critical scenes of a TV series may be tagged by the producer of the series with summary information such as character identifications, plot points, subplot points, full episode synopses, etc. In such a case, a first user (e.g., Joe) who watches every episode each week may be presented with only the most recent plot point. A second user (e.g., Mary), on the other hand, who watches the series via an online provider subscription each night, but stops in the middle of an episode and doesn't watch it again for six months, could be presented with the character identifications, critical plots for the entire season up to that point, and the plot and subplot points for the episode that she rejoins six months later.

Techniques described herein may therefore take into account the user's patterns (e.g., when read, frequency, familiarity) when generating content summaries in order to achieve the optimal level of detail/granularity. Accordingly, the user experience can be significantly enhanced

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
receiving a request for a presentation of media content to a user, wherein the media content includes one or more of an eBook, a movie, an episode of a television series, and a video game;
obtaining the media content;
determining a media consumption context associated with the user and the media content, wherein the media consumption context includes an amount of time between media consumption sessions;
determining a level of detail for a summary of the media content based on the media consumption context;
increasing the level of detail if the amount of time between media consumption sessions exceeds a threshold;
decreasing the level of detail if the amount of time between media consumption sessions does not exceed the threshold;
determining the summary based on the level of detail;
presenting the summary to the user, wherein the summary includes one or more of plot information and character information; and
presenting the media content to the user.

2. The method of claim 1, wherein the media consumption context further includes one or more of an amount of media consumed in a most recent media consumption session, an information retention capacity of the user, a complexity of the media content, a granularity input from the user, and a user preference setting.

3. The method of claim 1, wherein determining the summary includes obtaining the summary from a producer of the media content.

4. The method of claim 1, wherein determining the summary includes obtaining the summary from a crowd information source.

5. A computer implemented method comprising:
receiving a request for a presentation of media content to a user;
determining a media consumption context associated with the user and the media content, wherein the media consumption context includes an amount of time between media consumption sessions; and
determining a level of detail for a summary of the media content based on the media consumption context.

6. The method of claim 5, further including:
increasing the level of detail if the amount of time between media consumption sessions exceeds a threshold; and
decrease the level of detail if the amount of time between media consumption sessions does not exceed the threshold.

7. The method of claim 5, wherein the media consumption context further includes one or more of an amount of media consumed in a most recent media consumption session, an information retention capacity of the user, a complexity of the media content, a granularity input from the user, and a user preference setting.

8. The method of claim 5, further including:
obtaining the media content;
determining the summary based on the level of detail;
presenting the summary to the user; and
presenting the media content to the user.

9. The method of claim 8, wherein determining the summary includes obtaining the summary from a producer of the media content.

10. The method of claim 8, wherein determining the summary includes obtaining the summary from a crowd information source.

11. The method of claim 5, wherein the summary includes one or more of plot information and character information.

12. The method of claim 5, wherein the media content includes one or more of an eBook, a movie, an episode of a television series, and a video game.
